(19) United States
(12) Patent Application Publication
(10) Pub. No.: US 2007/0142063 A1
(43) Pub. Date: Jun. 21, 2007

(54) Positioning method and system

(75) Inventors: Chaucer Chiu, Taipei (TW); Peter Ge, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/313,159

(22) Filed: Dec. 19, 2005

(51) Int. Cl. H04Q 7/20

(52) U.S. Cl. 455/456.3

(57) ABSTRACT

A positioning method and system is proposed, which is used to select an appropriate positioning mode in order to acquire positioning server information according to actual environment and usage requirements of a mobile terminal equipment, the system includes a setting module, a reading module and a calling module. The method implements the steps of: dividing in advance a region into a plurality of subdomains, and respectively defining an identification and its corresponding positioning mode for each subdomain; when the mobile terminal equipment entering into one of the subdomains, reading the identification corresponding to the subdomain, then searching for the corresponding positioning mode according to the preset data, and acquiring the corresponding positioning service information through executing the positioning mode.

### BACKGROUND OF THE INVENTION

1. Field of the Invention

The present invention relates generally to a positioning technology, more particularly, to a positioning method and system that is capable of automatically selecting positioning mode to acquire the correlative service information.

2. Description of Related Art

LBS (Location Based Service) is capable of confirming actual geographic positions of mobile users by cooperation of mobile terminals and mobile networks, so as to provide correlative LBS information for users. Existing wireless positioning technology is a measuring method and computing method, i.e., positioning algorithm, to determine the position of a mobile terminal user. At present, there are many methods for computing position, the most common wireless positioning technology are categorized as follow:

GPS (Global Positioning System) positioning technology, of which the merits are in that positioning precision is high (relative positioning precision of the GPS within 50 KM can reach six to ten meters), GPS observation can be performed twenty—four hours a day without stopping, three dimensional coordinate can be provided, application is wide and so on. Drawbacks are in that since GPS is required to aim at a satellite, the positioning performance is degraded when the GPS device is surrounded by buildings or under bad weather, i.e., the positioning performance of GPS is affected greatly by geographic circumstances. In addition, since the GPS is required to transmit information continuously, requirement for life of a battery in a mobile electronic device with a GPS receiver installed therein is high.

GSM (Global System for Mobile Communication) positioning technology achieves positioning via base stations, of which the merits are in that it can be applied to crowded environment (e.g. buildings), mobile communication electronic devices employing the GSM positioning technology (e.g. mobile telephones) require no reconstruction and cost is low, thus it has gained popularity. Drawbacks are in that the position precision can only reach about 100 meter. Each wireless service provider needs to build their own monitoring sites. These providers often sets towers and base stations on straight roadways, which makes it difficult for two or three base stations to acquire a mobile phone signal simultaneously. In addition, it can only acquire two dimensional coordinate, that is, the height of a mobile user cannot be located. Moreover, positioning cannot be performed at places in which base station is not constructed, so that the GSM positioning is affected by locations of the base stations deployed by the wireless service providers.

Wireless positioning technology based on WLAN (Wireless Local Area Network), of which the major merit is in that it can fulfill high positioning precision (the average precision for positioning can reach one meter) from indoor to outdoor with some distance. Meanwhile, the positioning technology based on WLAN basically is not limited by geographic circumstances and layout of physical structures. Both positioning based on mobile stations and on networks can be adopted in the technology. At present, there are two main types of positioning method based on WLAN, one takes intensity values of signals received by the wireless terminal at the real-time stage and density chart of signal intensity collected by the wireless terminal at the off-line stage as conditions, and employs pattern matching to position. Merits of such method are in that positioning precision is quite high, the average precision can reach one to three meter; meanwhile, it is a pure software structure without additional support of hardware device. However, one shortcoming of this method is that it needs an off-line collecting stage for collecting a priori information under WLAN network circumstances required at the real-time positioning tracking stage. Workload of the collecting procedure is very large, and is readily affected by alteration of the circumstances. Another type of the method takes difference of the time that is needed for signals transmitted by the wireless terminal to arrive at each specific receiver as positioning condition, which is referred to as TDOA (Time Difference of Arrival). Advantage of such method is that it eliminates the above-mentioned problems associated with the off-line collecting stage, and meanwhile is not easily affected by alteration of the circumstances, but its precision is relatively lower; average precision for positioning generally reach three to five meter; meanwhile, it needs hardware signal receiver with built-in high time synchronization device.

Presently, most mobile terminal equipments with positioning function on the market use only one of the positioning techniques. However, during actual usage, due to various factors, such as environment, usage requirement, cost and the like, positioning functionality of the mobile terminal equipment may be limited to some extent, and cannot exert its due value. Accordingly, there exists a strong need in the art for a means to combine various positioning techniques, and automatically select a preferred positioning technique to provide correlative positioning information according to different applications and usage requirements.

### SUMMARY OF THE INVENTION

Accordingly, it is an objective of the present invention to solve the drawbacks of the aforementioned conventional technology by providing a positioning method and system that can combine various positioning techniques, so as to satisfy different circumstances and user requirements.

It is another objective of the present invention to provide a positioning method and system which can automatically select a preferred positioning technique to provide the correlative positioning information according to different applications and user requirements, so as to operate efficiently and conveniently.

In order to attain the above and other objectives, a positioning method and system is provided according to the present invention, which is applied in a mobile terminal equipment and used to acquire positioning service information through various positioning modes for the mobile terminal equipment, so as to meet different requirements, the system at least comprises a setting module for dividing a region into a plurality of subdomains, and respectively defining an identification and its corresponding positioning mode for each subdomain; a reading module for reading the identification of one of the subdomains when the mobile terminal equipment entering into the subdomain; and a calling module for searching for the positioning mode corresponding to the identification according to the setting information in the setting module, and acquiring the corresponding positioning service information through executing the positioning mode. Wherein, the system further comprises a setting database for storing identifications of subdomains and the corresponding positioning mode information defined by the setting module; a program database for storing a plurality of positioning service programs corresponding to respective positioning modes; and a positioning module for executing the positioning service program corresponding to the positioning mode, so as to acquire the corresponding positioning service information. The positioning mode is one of a pattern matching positioning technology, a TDOA (Time Difference of Arrival) positioning technology and a GPS (Global Positioning System) positioning technology. The mobile terminal equipment reads the identification of the subdomain by a RFID (Radio Frequency Identification) technique. The system is applied in a network communication system with a server and at least a mobile terminal equipment, and the reading module is disposed in the mobile terminal equipment. In addition, the mobile terminal equipment further comprises a first transmitting module for transmitting the identification read by the reading module to the server, and receiving the positioning server information passed back from the server. The setting module, calling module and positioning module are disposed in the server. In addition, the server further comprises a program database for storing a plurality of positioning service programs corresponding to respective positioning modes; a positioning module for executing the positioning service program corresponding to the positioning mode, so as to acquire the corresponding positioning service information; and a second transmitting module for receiving the identification transmitted by the mobile terminal equipment, and passing the positioning service information acquired by the positioning module back to the corresponding mobile terminal equipment.

The positioning method comprises the steps: dividing a region into a plurality of subdomains in advance, and respectively defining an identification and its corresponding positioning mode for to each of the subdomains; when the mobile terminal equipment entering into one of the subdomains, reading the identification corresponding to the subdomain; then searching for the positioning mode corresponding to the read identification, and acquiring the corresponding positioning service information through executing the positioning mode. Wherein, the method further comprises the step for storing the identification of each subdomain and the corresponding positioning mode information in a setting database. The positioning mode is one of a pattern matching positioning technology, a TDOA (Time Difference of Arrival) positioning technology and a GPS (Global Positioning System) positioning technology. The mobile terminal equipment reads the identification of the subdomain by a RFID (Radio Frequency Identification) technique. A plurality of positioning service programs respectively corresponding to positioning modes are stored in the mobile terminal equipment, and the corresponding positioning service information is acquired by executing the positioning service program corresponding to the positioning mode. The method is applied in a network communication system with a server and at least one mobile terminal equipment.

Compared with the conventional technology, the positioning method and system according to the present invention is capable of combining different positioning techniques, and automatically selecting a preferred positioning technique to execute the positioning service function according to different applications and user requirements, thereby satisfying user requirements, decreasing cost and enhancing operational convenience.

### BRIEF DESCRIPTION OF DRAWINGS

FIG. 1A depicts a block diagram of the basic structure of a positioning system according to a first embodiment of the present invention.

FIG. 1B depicts a block diagram of the basic structure of a positioning system according to a second embodiment of the present invention.

FIG. 2 depicts a flow chart of basic operational flow according to the positioning method of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be made without departing from the spirit of the present invention.

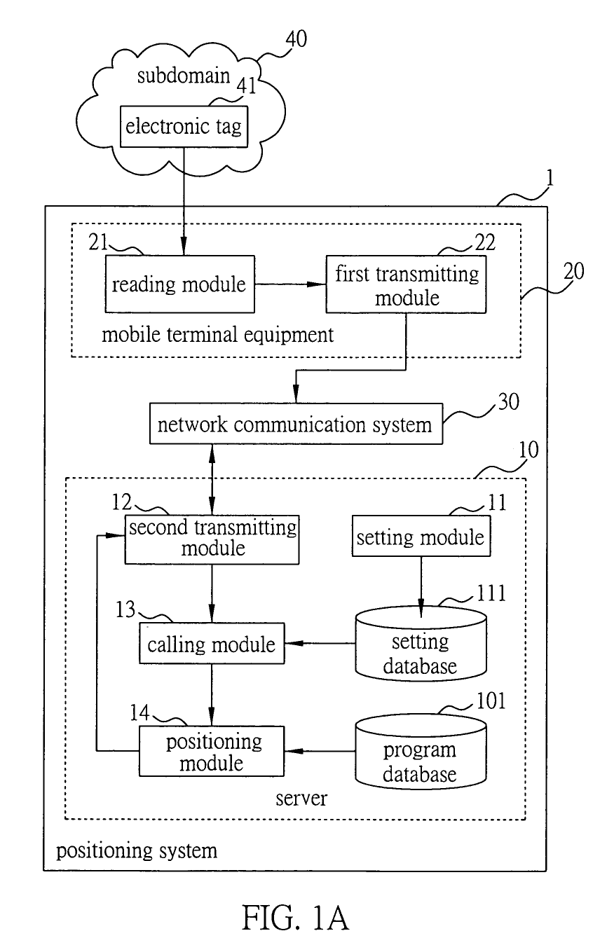

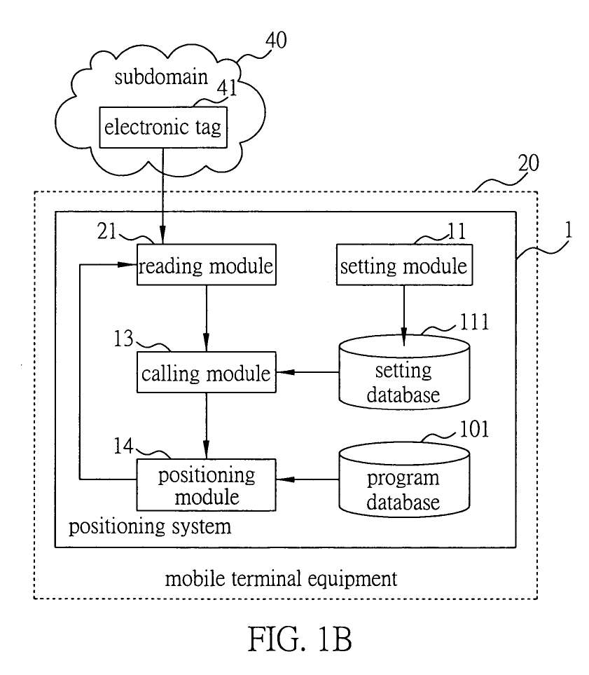

With reference to FIG. 1A, shown is a block diagram of the basic structure of positioning system 1 according to the first embodiment of the present invention. In the exemplary embodiment, the positioning system 1 is applied in a network communication system 30, a server 10 and a plurality of mobile terminal equipments 20. Wherein, the server 10 can be a workstation, a personal computer or a notebook computer or the like, while the mobile terminal equipments 20 can be, e.g., a palm computer, a PDA (Personal Digital Assistant), a mobile telephone or the like. Wherein, the server 10 further comprises a program database 101, a setting database 111, a setting module 11, a second transmitting module 12, a calling module 13 and a positioning module 14.

The program database 101 stores a plurality of positioning service programs, which correspond to various positioning modes (illustrated in detail later).

The setting database 111 is used to store setting results of the setting modules 11 (illustrated in detail later).

The setting module 11 is used to allow a user to divide a region into a plurality of subdomains 40 according to actual environment or application requirements, and respectively assigns identification to each subdomain 40. In the exemplary embodiment, ID information of each subdomain is stored in an electronic tag 41 (illustrated later). The electronic tag 41 can be provided at the entrance of each subdomain 40 so that it can be read upon the user entering into the subdomain 40. Next, a preferred positioning mode, e.g., pattern matching positioning technology, TDOA (Time Difference of Arrival) positioning technology, GPS (Global Positioning System) positioning technology and the like, is selected according to the characteristics of the environment and actual positioning requirement of the user for each subdomain 40. The identifications of various subdomains 40 and the corresponding positioning mode information are then stored in the setting database 111.

The second transmitting module 12 takes charge of information transmitting operations between the server 10 and the various mobile terminal equipments 20, which include receiving the ID transmitted by various mobile terminal equipments 20 and passing positioning service information acquired by the positioning module 14 back to the corresponding mobile terminal equipments 20. In the exemplary embodiment, various mobile terminal equipments 20 respectively has an unique identification code, when the second transmitting module 12 receives information transmitted by various mobile terminal equipments 20, the received information comprises identification code corresponding to respective mobile terminal equipments 20, such that the second transmitting module 12 is able to pass the correlative positioning service information back to the corresponding mobile terminal equipments 20 according to the identification code.

The calling module 13 is used to search and call a positioning mode corresponding to the ID transmitted by the mobile terminal equipments 20 according to the setting information in the setting database 111.

The positioning module 14 is used to search and execute the corresponding positioning service program according to the positioning mode called by the calling module 13, so as to acquire the corresponding positioning service information, e.g., geographic position information, etc.

The mobile terminal equipment 20 further comprises a reading module 21 and a first transmitting module 22.

The reading module 21 is used to read the ID of the subdomain 40 when the mobile terminal equipment enters into the subdomain 40. In the exemplary embodiment, the reading module 21 is a read/write device, which reads the ID of the subdomain by RFID (Radio Frequency Identification) technique.

The first transmitting module 22 is used to cooperate with the second transmitting module 12 in the server 10, and takes charge of information transmitting operations between the mobile terminal equipments 20 and the server 10, wherein, the information transmitting operations comprise transmitting the ID read by the reading module 21 to the server 10, and receiving the positioning service information passed back from the server 10.

It should be noted that positioning system 1 according to the present invention can also be applied solely in the mobile terminal equipments 20 (as illustrated in FIG. 1B), operations of various functional elements illustrated in FIG. 1B are identical to that illustrated in FIG. 1A, so they will not be illustrated again.

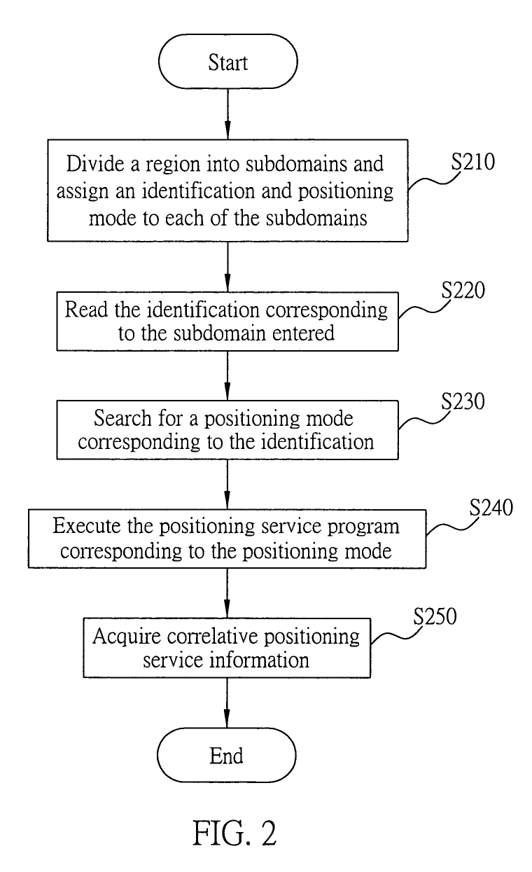

With reference to FIG. 2, shown is a basic operational flow chart of the positioning method according to the present invention. The positioning method according to the present invention can be applied in the presence of the network communication system 30, and also can be run solely in a single machine, e.g. the mobile terminal equipments 20 such as palm computers, PDAs and mobile phones and the like. Since both operating flows are basically the same, for the purpose of conciseness, the following only illustrates the processes of the method applied in the presence of network communication system 30.

As shown, firstly, step S210 is performed by dividing a region into a plurality of subdomains 40 according to conditions such as geographic characteristics of various regions and user's actual requirements, then, respectively defining an ID and a preferred positioning mode for each subdomain, and storing the setting information in the setting database 111 provided in the server 10. In this exemplary embodiment, the application field is a hospital, but the present invention is not limited to this, for example, the application field can also be a school etc. Firstly, the application field is divided into a plurality of subdomains 40 according to environment characteristics, e.g., various rooms inside and the regions outside, then, an ID is assigned to each divided subdomain 40. For each divided subdomain 40, subdomains requiring higher positioning precision and with substantially constant environment conditions may adopt the pattern matching positioning method whereas subdomains requiring only ordinary positioning precision but with variable environment conditions may adopt the TDOA positioning method; finally, the IDs of various subdomains are stored in the entrance of respective subdomains, e.g., in the electronic tag 41 of an access control system, and the IDs of various subdomains and their corresponding preferred positioning modes and the like are also stored in the setting database 111 in the server 10 for subsequent searching, then step S220 is performed.

At step S220, the ID of a subdomain 40 is read when a mobile terminal equipment 20 enters into that subdomain 40. In the exemplary embodiment, the mobile terminal equipment 20 can be a palm computer, a PDA, a mobile phone and the like. The reading module 21 is disposed in the mobile terminal equipment 20. In the exemplary embodiment, the mobile terminal equipment 20 can be a wrist band that can be wore on the wrist of the user, while reading module 21 is a read/write device. The access control system is provided at the entrance of various subdomains 40, when the user enters into the subdomain 40, the ID in the electronic tag 41 of the access control system can be read by the mobile terminal equipment 20 worn on the wrist, then step S230 is performed.

At step S230, the mobile terminal equipment 20 automatically transmits the read ID information to the server 10, thereby the server 10 can search for a positioning mode corresponding to the ID from the setting database 111, according to the received ID, then step S240 is performed.

At step S240, the server 10 searches for the corresponding positioning server program from a program database 101 according to the searched positioning mode, then step S250 is performed.

At step S250, the server 10 executes the positioning server program to acquire the positioning server information that is needed, e.g., geographic position information etc., and passes the positioning server information back to the corresponding mobile terminal equipment 20, thereby, the users can learn their geographic position in time.

As described above, the above positioning method and system according to the present invention can combine various positioning techniques and automatically select a positioning mode corresponding to the position technique from a plurality of positioning modes with different precisions according to various application fields and usage requirements, so as to satisfy different requirements of users. Additionally, its operation is simple and convenient. In addition, the present invention can also increase the application scope of the positioning devices, thereby decreasing cost.

What described above is to describe the exemplary preferred embodiments of the positioning method and system according to the present invention, it does not intend to limit the scope of essential technical contents of the present invention, but rather the scope of the positioning method and system according to the present invention is broadly defined in the appended claim or legal equivalents thereof.

What is claimed is:

1. A positioning method applied in a mobile terminal equipment for acquiring positioning service information through various positioning modes for the mobile terminal equipment, the method comprising:
dividing a region into a plurality of subdomains and respectively assigning an identification and a corresponding positioning mode for each of the subdomains;
reading the identification of one of the subdomains when the mobile terminal equipment entering into said subdomain; and
searching the positioning mode corresponding to the read identification and acquiring the corresponding positioning service information through executing the positioning mode.

2. The positioning method of claim 1, wherein the positioning mode is one of a pattern matching positioning technology and a TDOA (Time Difference of Arrival) positioning technology.

3. The positioning method of claim 1, wherein the mobile terminal equipment reads the identification of the subdomain by a RFID (Radio Frequency Identification) technique.

4. The positioning method of claim 1, further comprising switching the current positioning mode of the mobile terminal equipment to the positioning mode in correspondence with the read ID, and executing the positioning mode to acquire the corresponding positioning service information.

5. The positioning method of claim 1, wherein in the mobile terminal equipment a plurality of positioning service programs, respectively corresponding to each positioning mode, are stored.

6. The positioning method of claim 1, wherein the mobile terminal equipment is one of a palm computer, a PDA (personal Digital Assistant) and a mobile phone.

7. A positioning system applied in a mobile terminal equipment, comprising:
a setting module for dividing a region into a plurality of subdomains, and respectively defining an identification and the corresponding positioning for each of the subdomains;
a reading module for reading the identification of one of the subdomains when the mobile terminal equipment entering into said subdomain; and
a calling module for searching the positioning mode corresponding to the identification according to the setting information in the setting module and acquiring the corresponding positioning service information through executing the positioning mode.

8. The positioning system of claim 7, wherein the positioning mode is one of pattern matching positioning technology and TDOA (Time Difference Of Arrival) positioning technology.

9. The positioning system of claim 7, wherein the mobile terminal equipment reads the identification of the subdomain by a RFID (Radio Frequency Identification) technique.

10. The positioning system of claim 7, further comprising a program database for storing a plurality of positioning service programs respectively corresponding to each positioning mode.
